(19) United States
(12) Patent Application Publication
(10) Pub. No.: US 2012/0060654 A1
(43) Pub. Date: Mar. 15, 2012

(54) FAUCET NUT REMOVER SYSTEMS

(76) Inventor: William Swanson, Lake Wales, FL (US)

(21) Appl. No.: 13/192,895

(22) Filed: Jul. 28, 2011

Related U.S. Application Data
(60) Provisional application No. 61/382,995, filed on Sep. 15, 2010.

(51) Int. Cl. B25B 13/48; B25B 13/06

(52) U.S. Cl. 81/125

(57) ABSTRACT

Faucet Nut Remover provides a convenient and effective method for removing faucet nuts. The invention may comprise a piece of 1½″ square tubing with a hole at one end. Inside the tubing can be a spring-loaded shaft measuring approximately 3½″ in length, which may extend about 5/16″ beyond the tool. The top of the device preferably has four slats, one on each side, used to attach or remove a nut. A cut-out in the center of the tubing may show the spring component and the shaft as it retracts ⅞″ within the tubing. To use, consumers may simply reach under the desired faucet, securely attach the tool to a nut, and turn the device to unscrew the nut. It can be used to remove older sinks, or in new sink installations.

### CROSS-REFERENCE TO RELATED APPLICATION

The present application is related to and claims priority from prior U.S. provisional application Ser. No. 61/382,995, filed Sep. 15, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of tools and more specifically relates to a faucet nut removal tool.

2. Description of the Related Art

Faucets are used in many modem building constructions to provide access to water for occupants. These faucets are used to control water supply to bathtubs and sinks. Faucets tend to undergo corrosion during their use and often need to be removed and replaced. Old faucets that have been used for many years can develop corrosion on their brass components. The corrosion may restrict the mobility of the nuts adhered to these brass components, making them extremely difficult to remove when replacing or changing faucets. Traditional tools may be used to remove the nuts on recent installations, however conventional tools are often not suitably designed to ‘break loose’ heavily corroded nuts. Further, consumers may be required to assume contorted positions in order to view or access the nuts in an attempt to remove them to replace the faucets. This may cause consumers to strain their muscles or develop other injuries.

Various attempts have been made to solve the above-mentioned problems such as those found in U.S. Pat. Nos. 5,996,447; 5,542,321; 5,048,378; 7,231,852; 6,698,317; and D513,465. This prior art is representative of tools for use on sink and other such fixture installations. None of the above inventions and patents, taken either singly or in combination, is seen to describe the invention as claimed.

Ideally, a faucet nut removal tool should be user-friendly and, yet would operate reliably and be manufactured at a modest expense. Thus, a need exists for a reliable faucet nut removal tool system to avoid the above-mentioned problems.

### BRIEF SUMMARY OF THE INVENTION

In view of the foregoing disadvantages inherent in the known tool art, the present invention provides a novel faucet nut removal tool system. The general purpose of the present invention, which will be described subsequently in greater detail is to provide for ease of removal of faucet nuts.

A faucet nut removal tool is disclosed herein preferably comprising: a tool body assembly having, a tubing housing with a proximate and a distal end, the proximate end having a ratchet lug receiver, the distal end comprising an open end, and a spring-loaded shaft. The tubing housing preferably comprises exactly four slats; wherein the four slats are located one on each side of the tubing housing which is used to attach to and remove a faucet nut. In preferred embodiments the tubing housing comprises about 1½″ square tubing (preferably steel for durability and cost-effective manufacture—however it may comprise other suitable forms of ferrous materials and/or alloys). The spring-loaded shaft is about 3½″ in length and is able to extend about 5/16″ beyond the faucet nut removal tool. The spring-loaded shaft is a cylindrical rod which is extendable and retractable. The spring-loaded shaft is normally not under tension; however when in-use may be put under tension or compression. It should be appreciated that other lengths, widths and heights may be used and still be within the scope of the present invention; however the inventor has found the measurements stated to work well for its intended purpose and has thus provided it as an exemplary means whereby others may duplicate the invention. The exemplary dimensioning is in no way intended to be limiting.

The tubing housing preferably comprises a cut-out section in a center of the tubing housing to display the spring-loaded shaft as it retracts about ⅞″ within the tubing housing, a unique feature to help in determining the progression of the action of removing the faucet nut(s). The ratchet lug receiver is made to accommodate about a ½″ ratchet lug (smaller and larger sizes available—standard and/or metric) and/or an extension connected to the ratchet so that the user can remotely turn the device such that the sink isn't an obstacle (can work underneath it). The spring-loaded shaft and the tubing housing are able to frictionally engage the faucet nut, the tool body assembly is rotatable via a ratchet, the ratchet (or extension) inserted in the ratchet lug receiver; thus making the faucet nut removal tool manipulatable via the ratchet to remove and/or install a faucet nut.

A method of using a faucet nut removal tool is also disclosed herein preferably comprising the steps of: connecting the faucet nut removal tool to a ratchet; coupling the faucet nut removal tool to a faucet nut; activating the spring-loaded shaft; and rotating the faucet nut removal tool via the ratchet to remove the faucet nut. The method may further comprise the step of connecting an extension between the faucet nut removal tool and the ratchet for ease and convenience of use.

The present invention holds significant improvements and serves as a faucet nut removal tool system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, faucet nut removal tool, constructed and operative according to the teachings of the present invention.

FIG. 1 shows a perspective view illustrating a faucet nut removal tool in an in-use condition according to an embodiment of the present invention.

FIG. 2 is a perspective view illustrating the faucet nut removal tool according to an embodiment of the present invention of FIG. 1.

FIG. 3 is another perspective view illustrating the faucet nut removal tool according to an embodiment of the present invention of FIG. 1.

FIG. 4 is another perspective view illustrating the faucet nut removal tool according to an embodiment of the present invention of FIG. 1.

FIG. 5 is another perspective view illustrating the faucet nut removal tool as assembled with a ratchet according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a tool device and more particularly to a faucet nut remover as used to improve the ease of removing faucet nuts.

Generally speaking, faucet nut remover of the present invention provides a convenient and effective method for removing faucet nuts (corroded or not.) This innovative product preferably features a box-shaped, spring-loaded socket tool designed to engage and loosen faucet nuts. To use, consumers may simply reach under the basin, under a faucet, attach the top end of the device to a nut, and twist to unscrew the nut. Using this product may effectively eliminate the need for users to assume contorted positions in order to access faucet nuts which are typically enclosed within cabinet structures, and additionally may substantially eliminate the need for users to view the nuts at all during the removal process. Plumbers, handymen, and homeowners will benefit from the use of this product.

Faucet nut remover may comprise a piece of 1½″ square tubing with a hole at one end. Inside the tubing can be a spring-loaded shaft measuring approximately 3½″ in length, which may extend about 5/16″ beyond the tool. The top of the device preferably has four slats, one on each side, used to attach or remove a nut. A cut-out in the center of the tubing may show the spring component and the shaft as it retracts ⅞″ within the tubing. The present invention can be used when replacing older, existing sinks, or in new sink installations.

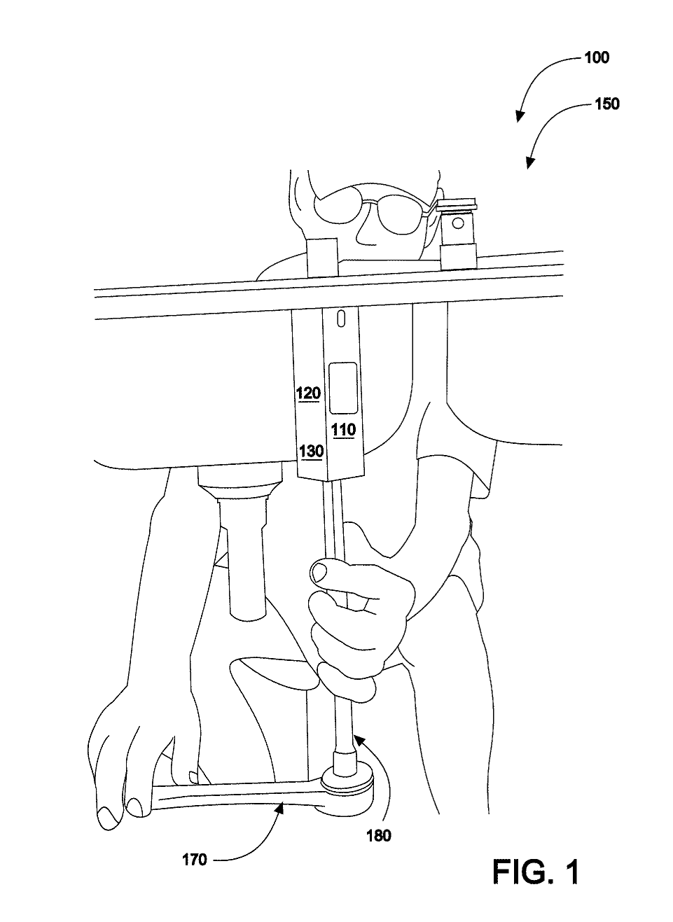

Referring to now more specifically to the drawings by numerals of reference there is shown in FIG. 1, a perspective view illustrating faucet nut removal tool 110 in an in-use condition 150 according to an embodiment of the present invention.

Faucet nut removal tool 110 of faucet nut removal tool system 100 preferably comprises: tool body assembly 120 having a tubing housing 130 with a proximate end 132 and a distal end 134. Proximate end 132 preferably has a ratchet lug receiver 140. Distal end 134 preferably comprises an open end 136 (sufficient to receive a faucet nut). Tool body assembly 120 also comprises spring-loaded shaft 160; wherein spring-loaded shaft 160 and tubing housing 130 are able to frictionally engage a faucet nut, tool body assembly 120 is rotatable via ratchet 170, ratchet 170 being insertable in a frictional coupled relationship with ratchet lug receiver 140. In this way faucet nut removal tool 110 is manipulatable via ratchet 170 to remove and/or install a faucet nut.

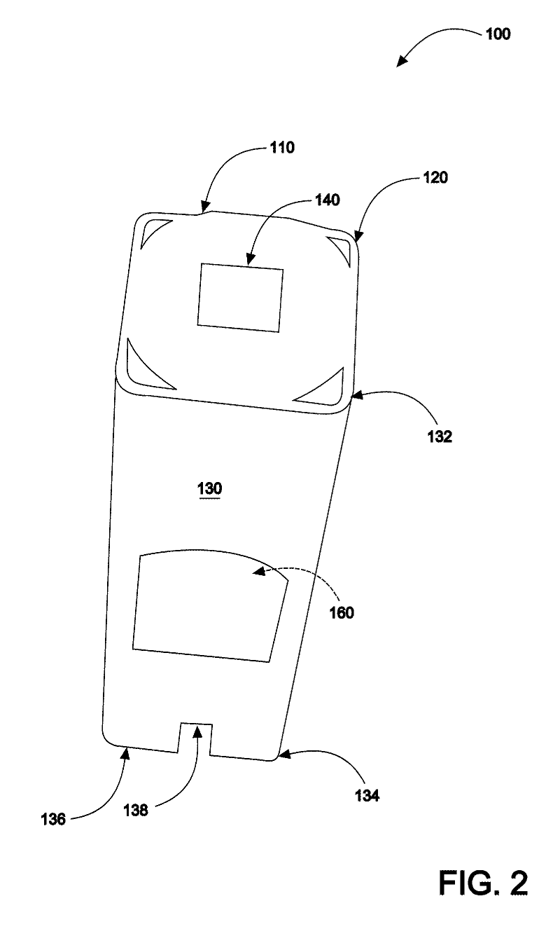

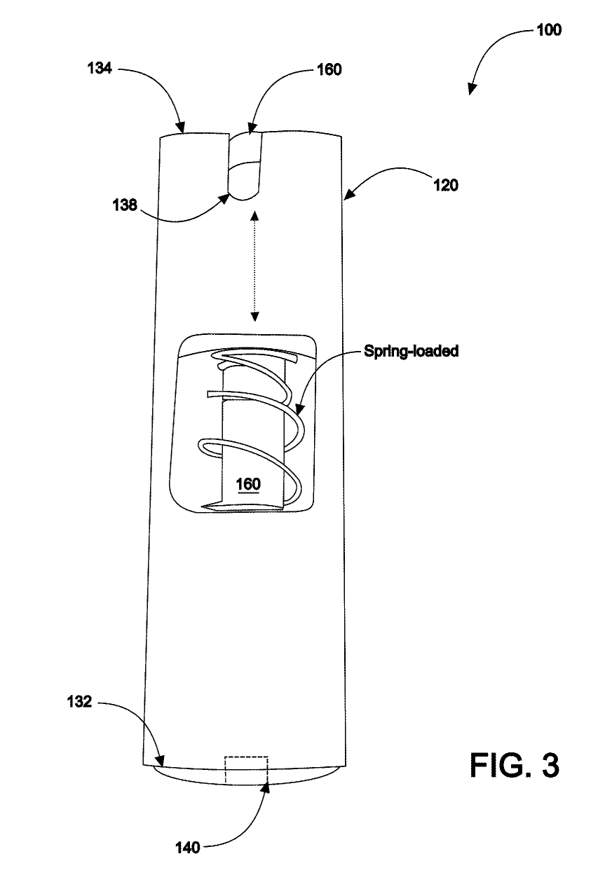

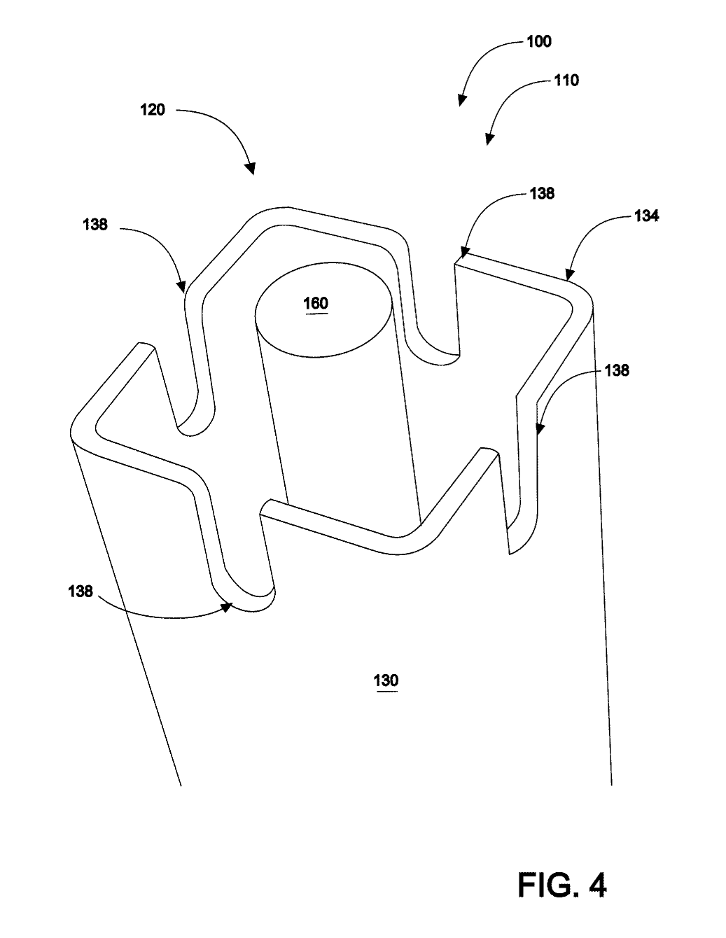

Referring now to FIGS. 2-5, perspective views illustrating faucet nut removal tool 110 according to an embodiment of the present invention of FIG. 1.

Tubing housing 130 preferably comprises about 1½″ steel square tubing in preferred embodiments. Spring-loaded shaft 160 also preferably comprises steel and is about 3½″ in length in the particular embodiment shown. Spring-loaded shaft 160 is able to extend about 5/16″ beyond faucet nut removal tool 110. Tubing housing 130 preferably comprises a cut-out section in a center of tubing housing 130 to display spring-loaded shaft 160 as it retracts about ⅞″ within tubing housing 130. Spring-loaded shaft 160 is normally not under tension or compression (other than the spring steel inherent properties), until in in-use condition 150. Spring-loaded shaft 160 is a cylindrical rod preferably comprising steel within the embodiment shown. Spring-loaded shaft 160 is retractable and extendable via the spring as it is used to contact-engage and manipulate the faucet nut during rotation periods.

Tubing housing 130 preferably comprises exactly four slats 138 located in open end 136; wherein four slats 138 are located one on each side of tubing housing 130 and is used to attach or remove the faucet nut.

Ratchet lug receiver is designed to accommodate a ½″ ratchet lug; however in alternate embodiments, ¾″ and ⅜″ ratchet lugs may be used. Upon reading this specification, it should be appreciated that, under appropriate circumstances, considering such issues as user preferences, design preference, structural requirements, marketing preferences, cost, available materials, technological advances, etc., other ratchet drive sizes and arrangements such as, for example, smaller, larger lugs, metric, standard, etc., may be sufficient.

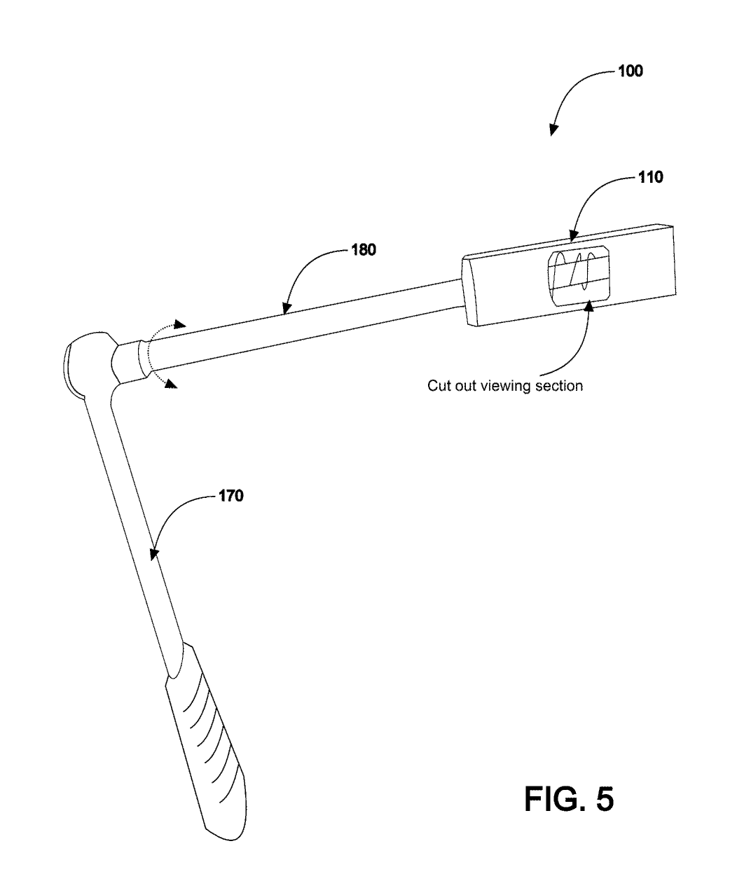

In typical situations wherein the user (operator) is attempting to remove faucet nuts from a sink installation (usually in a confined area) ratchet lug receiver 140 is able to accommodate an extension 180 connected to ratchet 170 (providing remote use such that the sink and traps are suitably maneuvered about.) Ratchet lug receiver 140 may further accommodate a detent located on the ratchet lug or on extension 180. FIG. 5, shows another perspective view illustrating faucet nut removal tool 110 as assembled with ratchet 170 also shown in FIG. 1.

A kit may be manufactured and sold with various sized faucet nut removal tools 110 and ratchets 170 and a set of user instructions.

A method of using a faucet nut removal tool preferably comprises the steps of: connecting faucet nut removal tool 110 to ratchet 170; coupling faucet nut removal tool 110 to a faucet nut; activating spring-loaded shaft 160; and rotating faucet nut removal tool 110 via ratchet 170 to remove at least one faucet nut. Extension 180 may be used between faucet nut removal tool 110 and ratchet 170.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, spraying penetrating fluid on the faucet nut(s) or the like, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A faucet nut removal tool comprising:
a tool body assembly having,
a tubing housing with a proximate and a distal end,
said proximate end having a ratchet lug receiver,
said distal end comprising an open end, and
a spring-loaded shaft;
wherein said spring-loaded shaft and said tubing housing are able to frictionally engage a faucet nut, said tool body assembly is rotatable via a ratchet, said ratchet inserted in said ratchet lug receiver; and
wherein said faucet nut removal tool is manipulatable via said ratchet to remove and/or install a faucet nut.

2. The faucet nut removal tool of claim 1 wherein said tubing housing comprises about 1½″ square tubing.

3. The faucet nut removal tool of claim 2 wherein said spring-loaded shaft is about 3½″ in length.

4. The faucet nut removal tool of claim 3 wherein said spring-loaded shaft is able to extend about 5/16″ beyond the faucet nut removal tool.

5. The faucet nut removal tool of claim 1 wherein said tubing housing comprises exactly four slats.

6. The faucet nut removal tool of claim 5 wherein said four slats are located one on each side of said tubing housing and is used to attach or remove said faucet nut.

7. The faucet nut removal tool of claim 6 wherein said tubing housing comprises a cut-out section in a center of the tubing housing to display the spring-loaded shaft as it retracts about ⅞″ within the tubing housing.

8. The faucet nut removal tool of claim 4 wherein said spring-loaded shaft is normally not under tension.

9. The faucet nut removal tool of claim 4 wherein said spring-loaded shaft is a cylindrical rod.

10. The faucet nut removal tool of claim 4 wherein said spring-loaded shaft is retractable via a spring.

11. The faucet nut removal tool of claim of claim 1 wherein said ratchet lug receiver accommodates a ½″ ratchet lug.

12. The faucet nut removal tool of claim of claim 1 wherein said ratchet lug receiver accommodates a ¾″ ratchet lug.

13. The faucet nut removal tool of claim of claim 1 wherein said ratchet lug receiver accommodates a ⅜″ ratchet lug.

14. The faucet nut removal tool of claim of claim 1 wherein said ratchet lug receiver accommodates an extension connected to said ratchet.

15. The faucet nut removal tool of claim of claim 1 wherein said ratchet lug receiver accommodates a detent on said ratchet lug.

16. The faucet nut removal tool of claim of claim 14 wherein said ratchet lug receiver accommodates a detent on said extension.

17. A faucet nut removal tool comprising:
a tool body assembly having,
a tubing housing with a proximate and a distal end,
said proximate end having a ratchet lug receiver,
said distal end comprising an open end, and
a spring-loaded shaft;
wherein said tubing housing comprises exactly four slats;
wherein said four slats are located one on each side of said tubing housing and is used to attach or remove a faucet nut;
wherein said tubing housing comprises about 1½″ square tubing;
wherein said spring-loaded shaft is about 3½″ in length;
wherein said spring-loaded shaft is able to extend about 5/16″ beyond the faucet nut removal tool;
wherein said spring-loaded shaft is a cylindrical rod;
wherein said spring-loaded shaft is retractable;
wherein said spring-loaded shaft is normally not under tension;
wherein said tubing housing comprises a cut-out section in a center of the tubing housing to display the spring-loaded shaft as it retracts about ⅞″ within the tubing housing;
wherein said ratchet lug receiver accommodates about a ½″ ratchet lug and/or an extension connected to said ratchet;
wherein said spring-loaded shaft and said tubing housing are able to frictionally engage said faucet nut, said tool body assembly is rotatable via a ratchet, said ratchet inserted in said ratchet lug receiver; and
wherein said faucet nut removal tool is manipulatable via said ratchet to remove and/or install said faucet nut.

18. A method of using a faucet nut removal tool comprising the steps of:
connecting said faucet nut removal tool to a ratchet;
coupling said faucet nut removal tool to a faucet nut;
activating a spring-loaded shaft; and
rotating said faucet nut removal tool via said ratchet to remove said faucet nut.

19. The method of using a faucet nut removal tool of claim 18 further comprising the step of connecting an extension between said faucet nut removal tool and said ratchet.
